(19) United States
(12) Patent Application Publication
(10) Pub. No.: US 2026/0151831 A1
(43) Pub. Date: Jun. 4, 2026

(54) Method of Manufacturing a Club Head Component

(71) Applicant: FUSHENG PRECISION CO., LTD., Taipei City (TW)

(72) Inventor: Chih-Wei LO, Taoyuan City (TW)

(21) Appl. No.: 19/363,702

(22) Filed: Oct. 21, 2025

(30) Foreign Application Priority Data
Nov. 29, 2024 (CN) 202411734415.1

(51) Int. Cl. B22F 12/41; B22F 1/00; B22F 1/05; B22F 12/10; B33Y 10/00; B33Y 40/20; B33Y 70/00; B33Y 80/00

(52) U.S. Cl. CPC B22F 12/41; B22F 1/05; B22F 1/09; B22F 12/10; B22F 2301/052; B22F 2301/35; B33Y 10/00; B33Y 40/20; B33Y 70/00; B33Y 80/00

(57) ABSTRACT

A method of manufacturing a club head component includes providing a powder material containing 7.3 to 8.35% by weight of aluminum, 0.75 to 1.25% of vanadium, 0.1 to 0.4% of iron, 0.75 to 1.25% of molybdenum, a balance of titanium, and unavoidable impurities, and 3D printing forming a semi-finished club head component with the powder material through a laser power of 120 to 180 W and a laser scanning speed of 700 to 1300 mm/s.

### CROSS REFERENCE TO RELATED APPLICATION

The application claims the benefit of China Application Serial No. 202411734415.1, filed on Nov. 29, 2024, and the entire contents of which are incorporated herein by reference.

### BACKGROUND OF THE INVENTION

### 1. Field of the Invention

The present invention relates to a method of manufacturing a club head component and, more particularly, to a method of manufacturing a club head component by 3D printing forming.

### 2. Description of the Related Art

Generally, when manufacturing components such as club head striking face plates or club head bodies, a molten metal can be poured into a mold and cooled to form a predetermined component. Alternatively, a metal block can be forged into a predetermined component through forging. However, club head components formed by casting molds and forging can only be formed into relatively simple shapes, making it difficult to meet customized and variable requirements. Therefore, when forming club head components, 3D printing is used to form club head components with predetermined shapes. However, club head components formed by 3D printing tend to develop pores on the surface, which leads to poor mechanical properties of the club head components.

In view of the consideration mentioned above, it is necessary to improve the existing method of manufacturing club head components.

### SUMMARY OF THE INVENTION

To solve the above problems, an object of the present application is to provide a method of manufacturing a club head component that can reduce surface porosity of the club head component.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

A method of manufacturing a club head component according to the present invention includes providing a powder material containing 7.3 to 8.35% by weight of aluminum, 0.75 to 1.25% of vanadium, 0.1 to 0.4% of iron, 0.75 to 1.25% of molybdenum, a balance of titanium, and unavoidable impurities, and 3D printing forming a semi-finished club head component with the powder material through a laser power of 120 to 180 W and a laser scanning speed of 700 to 1300 mm/s.

Therefore, the method of manufacturing a club head component of the present application, through 3D printing forming the semi-finished club head component through predetermined laser power and laser scanning speed, can reduce surface pores of the semi-finished club head component, thereby avoiding poor mechanical properties caused by pores, and can achieve the effect of making the semi-finished club head component have better quality.

In an example, the powder material has a particle size ranging from 15 to 53 μm. Thus, the effect of being used for 3D printing forming the semi-finished club head component can be achieved.

In an example, 3D printing forming the semi-finished club head component is carried out with the powder material through a laser power of 170 W and a scanning speed of 1250 mm/s. Thus, the effect of reducing surface pores of the semi-finished club head component can be achieved.

In an example, the method of manufacturing a club head component further includes performing an annealing treatment on the semi-finished club head component, and the annealing treatment is carried out by heating the semi-finished club head component to 550 to 850° C. and maintaining for 90 to 360 minutes. Thus, the effect of making the semi-finished club head component have better mechanical properties can be achieved.

In an example, the annealing treatment is carried out by heating the semi-finished club head component to 600 to 800° C. and maintaining for 90 to 360 minutes. Thus, the effect of making the semi-finished club head component have better mechanical properties can be achieved.

In an example, the semi-finished club head component after the annealing treatment has a yield strength ranging from 160 to 185 ksi, a tensile strength ranging from 160 to 195 ksi, an elongation rate ranging from 5 to 15%, and a hardness ranging from 40 to 43 HRC. Thus, the effect that the semi-finished club head component has better strength can be achieved.

In an example, the semi-finished club head component has a densification greater than 99.6% per 10 mm² of surface. Thus, the effect of avoiding poor mechanical properties of the semi-finished club head component caused by surface pores can be achieved.

### DETAILED DESCRIPTION OF THE INVENTION

In order to make the above and other objectives, features, and advantages of the present invention clearer and easier to understand, the preferred embodiments of the present invention will be described hereinafter.

A preferred embodiment of the method of manufacturing a club head component of the present application includes 3D printing forming a semi-finished club head component with a powder material.

The powder material may be an alloy powder, the powder material may have a particle size ranging from 15 to 53 μm, and the powder material may be formed through specific composition ratios of various metallic elements and non-metallic elements to form a club head component with good mechanical properties. In this embodiment, the powder material may include 7.3 to 8.35% by weight of aluminum (Al), 0.75 to 1.25% of vanadium (V), 0.1 to 0.4% of iron (Fe), 0.75 to 1.25% of molybdenum (Mo), a balance of titanium (Ti), and unavoidable impurities. Thus, the powder material can be formed into a semi-finished club head component with better mechanical properties.

The powder material may be 3D printing formed into the semi-finished club head component through laser sintering, for example, through 3D printing technologies such as SLM (selective laser melting) to form the semi-finished club head component. In this embodiment, after laying the powder material of predetermined thickness on a platform, for example, the powder material may be sintered by laser to form a cross section of the semi-finished club head component, which may be, for example, a club head body, a striking face plate, or a club head cap. After laminating the predetermined thickness of the powder material on the cross section of the semi-finished club head component, the powder material is sintered again by laser. Thus repeatedly laminating to form the semi-finished club head component. Furthermore, irradiating the powder material with a laser power of 120 to 180 W and a laser scanning speed of 700 to 1300 mm/s. Thus, through the above appropriate laser power and laser scanning speed, the porosity on the surface of the semi-finished club head component can be reduced, making the densification greater than 99.6% per 10 mm² of the surface of the semi-finished club head component, thereby making the surface of the semi-finished club head component have better densification.

Furthermore, the method of manufacturing a club head component of the present application may also include subsequently performing a heat treatment on the semi-finished club head component to make the semi-finished club head component have better mechanical properties. It is worth noting that corresponding heat treatments can be performed on semi-finished club head components formed from different powder materials. In this embodiment, the semi-finished club head component undergoes an annealing treatment. Specifically, the annealing treatment may include heating the semi-finished club head component to a predetermined temperature above the recrystallization temperature of the semi-finished club head component, maintaining the predetermined temperature for a period of time, and then cooling slowly. Thus, the ductility and toughness of the semi-finished club head component can be improved, and internal residual stress can be released. Furthermore, the annealing treatment may include heating the semi-finished club head component to 550 to 850° C. and maintaining for 90 to 360 minutes, preferably, the annealing treatment may include heating the semi-finished club head component to 600 to 800° C. and maintaining for 90 to 360 minutes. Therefore, the semi-finished club head component can have a yield strength ranging from 160 to 185 ksi, a tensile strength ranging from 160 to 195 ksi, an elongation rate ranging from 5 to 15%, and a hardness ranging from 40 to 43 HRC.

Subsequently testing the number of pores in the semi-finished club head component formed under the 3D printing conditions shown in Table 1, the results are shown in Table 2.

TABLE 1
Different 3D printing conditions

| Group | Laser powers (W) | Laser scanning speed (mm/s) |
|---|---|---|
| 1 | 120 | 650 |
| 2 | | 850 |
| 3 | | 1050 |
| 4 | | 1250 |
| 5 | 150 | 650 |
| 6 | | 850 |
| 7 | | 1050 |
| 8 | | 1250 |
| 9 | 170 | 1250 |
| 10 | | 650 |
| 11 | 180 | 850 |
| 12 | | 1050 |
| 13 | | 1250 |

TABLE 2
Number of pores larger than 30 μm in each group

| | Number of pores larger than 30 μm in |
|---|---|
| Group | diameter |
| 1 | Plenty of pores |
| 2 | 8 |
| 3 | 0 |
| 4 | 8 |
| 5 | Plenty of pores |
| 6 | 15 |
| 7 | 2 |
| 8 | 0 |
| 9 | 0 |
| 10 | Plenty of pores |
| 11 | 21 |
| 12 | 3 |
| 13 | 0 |

From Table 2, it can be seen that in the method of manufacturing a club head component of the present application, after irradiating the powder material at a laser scanning speed of 650 mm/s to form the semi-finished club head component, many pores form on the surface of the semi-finished club head component (Groups 1, 5, 10). When the laser scanning speed is increased, the formation of pores can be significantly reduced. Therefore, further testing was conducted on the effect of different laser powers on densification at a high laser scanning speed of 1250 mm/s (Groups 8, 9, 13), with four repetitions for each group test, and the results are shown in Table 3.

TABLE 3
Effect of different laser powers on densification

| | Densification per 10 mm² of | |
|---|---|---|
| Group | surface (%) | Average % |
| 8 | 99.970 | 99.980 |
| | 99.985 | |
| | 99.986 | |
| | 99.978 | |
| 9 | 99.996 | 99.991 |
| | 99.988 | |
| | 99.987 | |
| | 99.993 | |
| 13 | 99.980 | 99.972 |
| | 99.943 | |
| | 99.995 | |
| | 99.968 | |

From Table 3, it can be seen that in the method of manufacturing a club head component of the present application, at a laser scanning speed of 1250 mm/s, forming the semi-finished club head component with a laser power of 170 W can obtain a semi-finished club head component with better densification (Group 9). Subsequently testing the mechanical properties of the Group 9 semi-finished club head component after annealing treatment conditions, with several repetitions for each annealing treatment condition. The results are shown in Table 4. From Table 4, it can be seen that compared with no annealing treatment, after the annealing treatment, the mechanical properties of the semi-finished club head component can be significantly improved, thereby further enhancing the strength of the semi-finished club head component.

TABLE 4
Effect of heat treatment conditions on mechanical properties

| | Tensile | Yield | | Young's | Rockwell |
|---|---|---|---|---|---|
| Annealing | strength | strength | Elongation | modules | Hardness |
| treatment | (ksi) | (ksi) | rate (%) | (GPa) | (HRC) |
| w/o | 176.60 | 152.78 | 15.88 | 113 | 37.0 |
| | 176.69 | 152.40 | 11.60 | 118 | 38.3 |
| 550° C. | 194.57 | 183.23 | 3.56 | 120 | 41.5 |
| annealing, | 194.63 | 186.02 | 7.32 | 120 | 41.8 |
| 1 hr | | | | | |
| 550° C. | 195.07 | 183.91 | 6.6 | 123 | 42.9 |
| annealing, | 194.79 | 183.99 | 5.80 | 119 | 43.1 |
| 5 hr | 196.98 | 187.0 | 6.36 | 126 | 41.7 |
| 650° C. | 186.79 | 179.26 | 5.12 | 121 | 41.0 |
| annealing, | 187.77 | 179.18 | 8.36 | 121 | 40.8 |
| 1 hr | | | | | |
| 650° C. | 183.13 | 174.74 | 6.00 | 127 | 40.8 |
| annealing, | 184.44 | 176.49 | 8.04 | 122 | 41.1 |
| 5 hr | 184.52 | 176.30 | 9.04 | 122 | 40.6 |
| 810° C. | 163.42 | 156.81 | 15.32 | 124 | 35.3 |
| annealing, | 163.16 | 156.39 | 12.04 | 119 | 35.6 |
| 4 hr | 163.57 | 158.43 | 16.72 | 129 | 35.7 |
| | 163.23 | 158.05 | 16.08 | 128 | 35.5 |

In view of the foregoing, the method of manufacturing a club head component of the present application, through 3D printing forming the semi-finished club head component through predetermined laser power and laser scanning speed, can reduce surface pores of the semi-finished club head component, thereby avoiding poor mechanical properties caused by pores, and can achieve the effect of making the semi-finished club head component have better quality.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. A method of manufacturing a club head component, comprising:
providing a powder material containing 7.3 to 8.35% by weight of aluminum, 0.75 to 1.25% of vanadium, 0.1 to 0.4% of iron, 0.75 to 1.25% of molybdenum, a balance of titanium, and unavoidable impurities; and
3D printing forming a semi-finished club head component with the powder material through a laser power of 120 to 180 W and a laser scanning speed of 700 to 1300 mm/s.

2. The method of manufacturing the club head component as claimed in claim 1, wherein the powder material has a particle size ranging from 15 to 53 μm.

3. The method of manufacturing the club head component as claimed in claim 1, wherein 3D printing forming the semi-finished club head component is carried out with the powder material through a laser power of 170 W and a scanning speed of 1250 mm/s.

4. The method of manufacturing the club head component as claimed in claim 1, further comprising: performing an annealing treatment on the semi-finished club head component, wherein the annealing treatment is carried out by heating the semi-finished club head component to 550 to 850° C. and maintaining for 90 to 360 minutes.

5. The method of manufacturing the club head component as claimed in claim 4, wherein the annealing treatment is carried out by heating the semi-finished club head component to 600 to 800° C. and maintaining for 90 to 360 minutes.

6. The method of manufacturing the club head component as claimed in claim 4, wherein the semi-finished club head component after the annealing treatment has a yield strength ranging from 160 to 185 ksi, a tensile strength ranging from 160 to 195 ksi, an elongation rate ranging from 5 to 15%, and a hardness ranging from 40 to 43 HRC.

7. The method of manufacturing the club head component as claimed in claim 1, wherein the semi-finished club head component has a densification greater than 99.6% per 10 mm² of surface.
